(19) United States
(12) Patent Application Publication
(10) Pub. No.: US 2014/0365392 A1
(43) Pub. Date: Dec. 11, 2014

(54) WEIGHTED-CHARACTERISTICS SHIPPING ESTIMATION SYSTEM AND METHOD

(71) Applicant: VeriTread, LLC, Mulberry, FL (US)

(72) Inventor: Jeffrey G. Cox, JR., Lakeland, FL (US)

(21) Appl. No.: 13/911,370

(22) Filed: Jun. 6, 2013

(51) Int. Cl. G06Q 10/08

(52) U.S. Cl. CPC G06Q 10/08345
USPC 705/335

(57) ABSTRACT

A method, computer program product, and computing system for initiating a shipping inquiry for a specific piece of heavy equipment having a defined manufacturer/model. An equipment database is accessed to obtain a plurality of equipment characteristics for the specific piece of heavy equipment, wherein at least one of the equipment characteristics is assigned a weight, based at least in part, upon a level of shipping complexity associated with the equipment characteristic. The shipping estimate is calculated for the specific piece of heavy equipment based, at least in part, upon the defined manufacturer/model of the specific piece of heavy equipment, and one or more of the plurality of equipment characteristics.

### TECHNICAL FIELD

This disclosure relates to shipping estimation systems and, more particularly, to shipping estimation systems for use when shipping heavy equipment.

### BACKGROUND

Shipping estimation systems are used to approximate the shipping cost associated with transferring a product from a first location to a second location. For example, many e-commerce websites have shipping estimation tools that will calculate the cost associated with delivering a product, taking into consideration details like product size, weight and shipping methodology. However, such systems only approximate the shipping cost for shipping products that are comparatively easy to ship (e.g., boxed and light in weight).

Unfortunately, performing such calculations becomes more difficult when e.g., the product does not fit within a box. For example, when shipping heavy equipment (e.g., bulldozers and excavators), the calculation of such shipping costs become quite complicated, as numerous things need to be considered, such as size, weight, disassembly time, reassembly time, permits, and shipping vehicle requirements.

### Summary of Disclosure

In one implementation, a computer-implemented method for providing a shipping estimate to a user includes initiating a shipping inquiry for a specific piece of heavy equipment having a defined manufacturer/model. An equipment database is accessed to obtain a plurality of equipment characteristics for the specific piece of heavy equipment, wherein at least one of the equipment characteristics is assigned a weight, based at least in part, upon a level of shipping complexity associated with the equipment characteristic. The shipping estimate is calculated for the specific piece of heavy equipment based, at least in part, upon the defined manufacturer/model of the specific piece of heavy equipment, and one or more of the plurality of equipment characteristics.

One or more of the following features may be included. A starting location for the specific piece of heavy equipment may be identified. A destination location for the specific piece of heavy equipment may be identified. Calculating the shipping estimate for the specific piece of heavy equipment may include calculating the shipping estimate for the specific piece of heavy equipment based, at least in part, upon the defined manufacturer/model of the specific piece of heavy equipment, one or more of the plurality of equipment characteristics, the starting location of the specific piece of heavy equipment, and the destination location of the specific piece of heavy equipment. The shipping estimate may be provided to the user.

Calculating the shipping estimate for the specific piece of heavy equipment may include providing the defined manufacturer/model of the specific piece of heavy equipment, and one or more of the plurality of equipment characteristics to one or more service providers; and receiving one or more bids from the one or more service providers. The shipping estimate may be based, at least in part, upon the one or more bids received from the one or more service providers. The plurality of equipment characteristics may define one or more physical characteristics of the specific piece of heavy equipment. Each of the plurality of equipment characteristics may be assigned a weight, based at least in part, upon the level of shipping complexity associated with the equipment characteristic.

In another implementation, a computer program product resides on a computer readable medium and has a plurality of instructions stored on it. When executed by a processor, the instructions cause the processor to perform operations including initiating a shipping inquiry for a specific piece of heavy equipment having a defined manufacturer/model. An equipment database is accessed to obtain a plurality of equipment characteristics for the specific piece of heavy equipment, wherein at least one of the equipment characteristics is assigned a weight, based at least in part, upon a level of shipping complexity associated with the equipment characteristic. The shipping estimate is calculated for the specific piece of heavy equipment based, at least in part, upon the defined manufacturer/model of the specific piece of heavy equipment, and one or more of the plurality of equipment characteristics.

One or more of the following features may be included. A starting location for the specific piece of heavy equipment may be identified. A destination location for the specific piece of heavy equipment may be identified. Calculating the shipping estimate for the specific piece of heavy equipment may include calculating the shipping estimate for the specific piece of heavy equipment based, at least in part, upon the defined manufacturer/model of the specific piece of heavy equipment, one or more of the plurality of equipment characteristics, the starting location of the specific piece of heavy equipment, and the destination location of the specific piece of heavy equipment. The shipping estimate may be provided to the user.

Calculating the shipping estimate for the specific piece of heavy equipment may include providing the defined manufacturer/model of the specific piece of heavy equipment, and one or more of the plurality of equipment characteristics to one or more service providers; and receiving one or more bids from the one or more service providers. The shipping estimate may be based, at least in part, upon the one or more bids received from the one or more service providers. The plurality of equipment characteristics may define one or more physical characteristics of the specific piece of heavy equipment. Each of the plurality of equipment characteristics may be assigned a weight, based at least in part, upon the level of shipping complexity associated with the equipment characteristic.

In another implementation, a computing system including a processor and memory is configured to perform operations including initiating a shipping inquiry for a specific piece of heavy equipment having a defined manufacturer/model. An equipment database is accessed to obtain a plurality of equipment characteristics for the specific piece of heavy equipment, wherein at least one of the equipment characteristics is assigned a weight, based at least in part, upon a level of shipping complexity associated with the equipment characteristic. The shipping estimate is calculated for the specific piece of heavy equipment based, at least in part, upon the defined manufacturer/model of the specific piece of heavy equipment, and one or more of the plurality of equipment characteristics.

One or more of the following features may be included. A starting location for the specific piece of heavy equipment may be identified. A destination location for the specific piece of heavy equipment may be identified. Calculating the shipping estimate for the specific piece of heavy equipment may include calculating the shipping estimate for the specific piece of heavy equipment based, at least in part, upon the defined manufacturer/model of the specific piece of heavy equipment, one or more of the plurality of equipment characteristics, the starting location of the specific piece of heavy equipment, and the destination location of the specific piece of heavy equipment. The shipping estimate may be provided to the user.

Calculating the shipping estimate for the specific piece of heavy equipment may include providing the defined manufacturer/model of the specific piece of heavy equipment, and one or more of the plurality of equipment characteristics to one or more service providers; and receiving one or more bids from the one or more service providers. The shipping estimate may be based, at least in part, upon the one or more bids received from the one or more service providers. The plurality of equipment characteristics may define one or more physical characteristics of the specific piece of heavy equipment. Each of the plurality of equipment characteristics may be assigned a weight, based at least in part, upon the level of shipping complexity associated with the equipment characteristic.

The details of one or more implementations are set forth in the accompanying drawings and the description below. Other features and advantages will become apparent from the description, the drawings, and the claims.

### BRIEF DESCRIPTION OF THE DRAWINGS

FIG. 1 is a diagrammatic view of a distributed computing network including a computing device that executes a shipping estimation process according to an implementation of the present disclosure;

FIG. 2 is a first flowchart of the shipping estimation process of FIG. 1 according to an implementation of the present disclosure;

FIG. 3 is a diagrammatic view of a graphical user interface rendered by the shipping estimation process of FIG. 1 according to an implementation of the present disclosure;

FIG. 4 is another diagrammatic view of a graphical user interface rendered by the shipping estimation process of FIG. 1 according to an implementation of the present disclosure; and

FIG. 5 is another diagrammatic view of a graphical user interface rendered by the shipping estimation process of FIG. 1 according to an implementation of the present disclosure.

Like reference symbols in the various drawings indicate like elements.

### DETAILED DESCRIPTION OF THE PREFERRED EMBODIMENTS

### Introduction

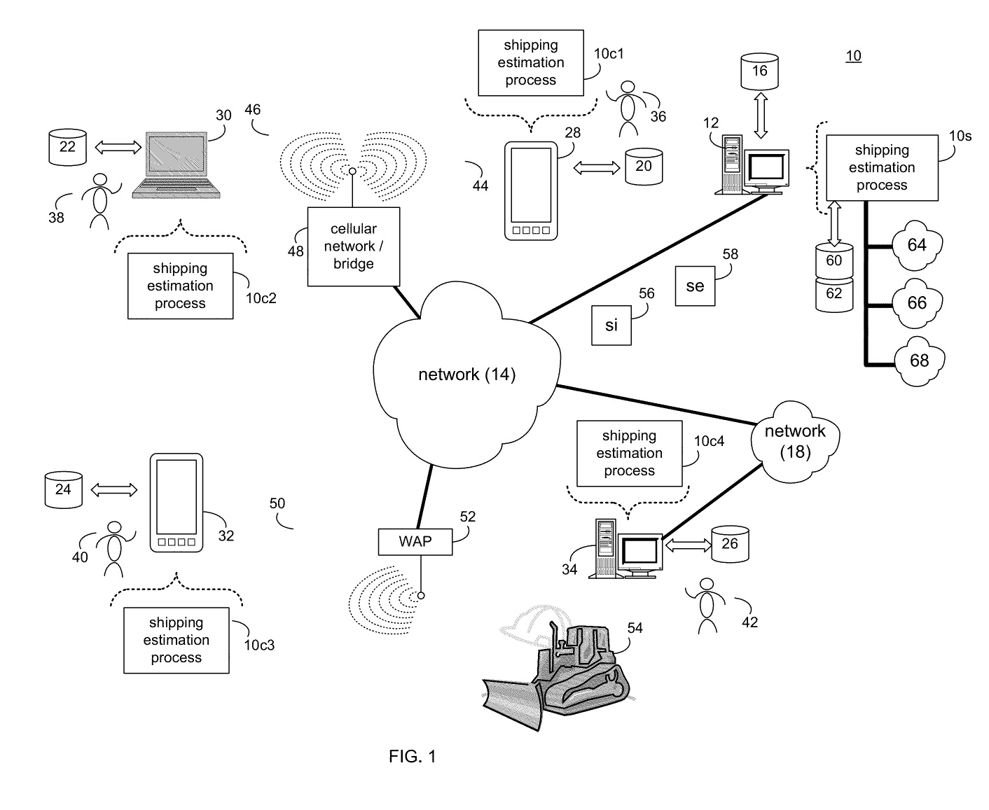

In FIG. 1, there is shown shipping estimation process 10. Shipping estimation process 10 may be implemented as a server-side process, a client-side process, or a hybrid server-side/client-side process. For example, shipping estimation process 10 may be implemented as a purely server-side process via shipping estimation process 10s. Alternatively, shipping estimation process 10 may be implemented as a purely client-side process via one or more of shipping estimation process 10c1, shipping estimation process 10c2, shipping estimation process 10c3, and shipping estimation process 10c4. Alternatively still, shipping estimation process 10 may be implemented as a hybrid server-side/client-side process via shipping estimation process 10s in combination with one or more of shipping estimation process 10c1, shipping estimation process 10c2, shipping estimation process 10c3, and shipping estimation process 10c4. Accordingly, shipping estimation process 10 as used in this disclosure may include any combination of shipping estimation process 10s, shipping estimation process 10c1, shipping estimation process 10c2, shipping estimation process 10c3, and shipping estimation process 10c4.

Shipping estimation process 10s may be a server application and may reside on and may be executed by computing device 12, which may be connected to network 14 (e.g., the Internet or a local area network). Examples of computing device 12 may include, but are not limited to: a personal computer, a laptop computer, a personal digital assistant, a data-enabled cellular telephone, a notebook computer, a television with one or more processors embedded therein or coupled thereto, a server computer, a series of server computers, a mini computer, a mainframe computer, or a dedicated network device.

The instruction sets and subroutines of shipping estimation process 10s, which may be stored on storage device 16 coupled to computing device 12, may be executed by one or more processors (not shown) and one or more memory architectures (not shown) included within computing device 12. Examples of storage device 16 may include but are not limited to: a hard disk drive; a tape drive; an optical drive; a RAID device; a random access memory (RAM); a read-only memory (ROM); and all forms of flash memory storage devices.

Network 14 may be connected to one or more secondary networks (e.g., network 18), examples of which may include but are not limited to: a local area network; a wide area network; or an intranet, for example.

Examples of shipping estimation processes 10c1, 10c2, 10c3, 10c4 may include but are not limited to a web browser, a web browser plug-in or applet, a game console user interface, a video conference user interface, or a specialized application (e.g., an application running on e.g., the Android™ platform or the iOS™ platform). The instruction sets and subroutines of shipping estimation processes 10c1, 10c2, 10c3, 10c4, which may be stored on storage devices 20, 22, 24, 26 (respectively) coupled to client electronic devices 28, 30, 32, 34 (respectively), may be executed by one or more processors (not shown) and one or more memory architectures (not shown) incorporated into client electronic devices 28, 30, 32, 34 (respectively). Examples of storage devices 20, 22, 24, 26 may include but are not limited to: hard disk drives; tape drives; optical drives; RAID devices; random access memories (RAM); read-only memories (ROM), and all forms of flash memory storage devices.

Examples of client electronic devices 28, 30, 32, 34 may include, but are not limited to, data-enabled, cellular telephone 28, laptop computer 30, personal digital assistant 32, personal computer 34, a notebook computer (not shown), a server computer (not shown), a gaming console (not shown), a television (not shown), a tablet computer (not shown) and a dedicated network device (not shown). Client electronic devices 28, 30, 32, 34 may each execute an operating system, examples of which may include but are not limited to Microsoft Windows™, Android™, WebOS™, iOS™, Redhat Linux™, or a custom operating system.

The various client electronic devices (e.g., client electronic devices 28, 30, 32, 34) may be directly or indirectly coupled to network 14 (or network 18). For example, data-enabled, cellular telephone 28 and laptop computer 30 are shown wirelessly coupled to network 14 via wireless communication channels 44, 46 (respectively) established between data-enabled, cellular telephone 28, laptop computer 30 (respectively) and cellular network/bridge 48, which is shown directly coupled to network 14. Further, personal digital assistant 32 is shown wirelessly coupled to network 14 via wireless communication channel 50 established between personal digital assistant 32 and wireless access point (i.e., WAP) 52, which is shown directly coupled to network 14. Additionally, personal computer 34 is shown directly coupled to network 18 via a hardwired network connection.

WAP 52 may be, for example, an IEEE 802.11a, 802.11b, 802.11g, 802.11n, Wi-Fi, and/or Bluetooth device that is capable of establishing wireless communication channel 50 between personal digital assistant 32 and WAP 52. As is known in the art, IEEE 802.11x specifications may use Ethernet protocol and carrier sense multiple access with collision avoidance (i.e., CSMA/CA) for path sharing. The various 802.11x specifications may use phase-shift keying (i.e., PSK) modulation or complementary code keying (i.e., CCK) modulation, for example. As is known in the art, Bluetooth is a telecommunications industry specification that allows e.g., mobile phones, computers, and personal digital assistants to be interconnected using a short-range wireless connection.

### Shipping Estimation Process

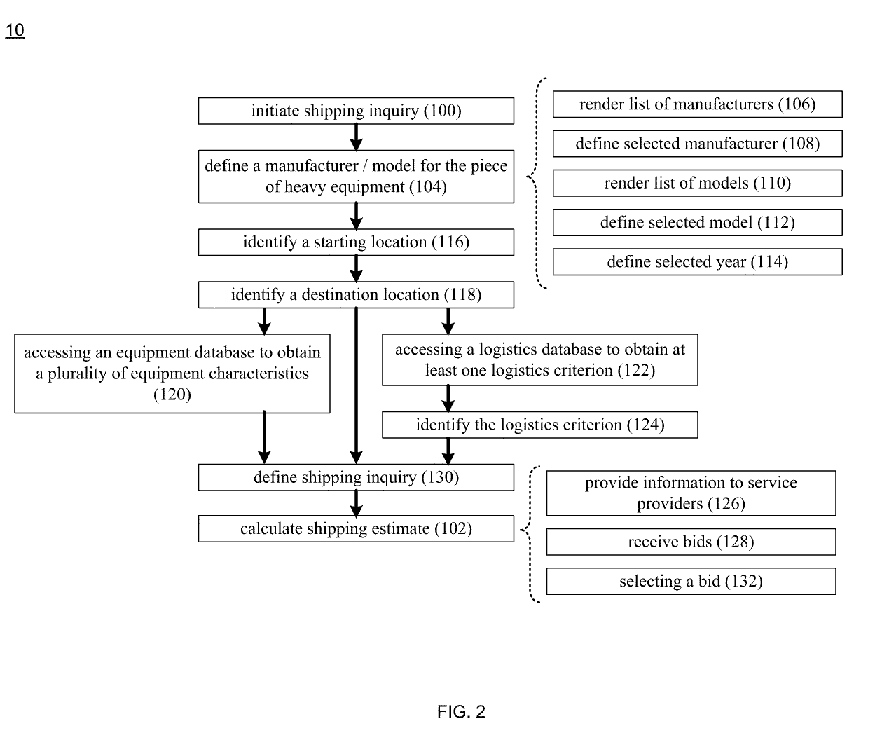

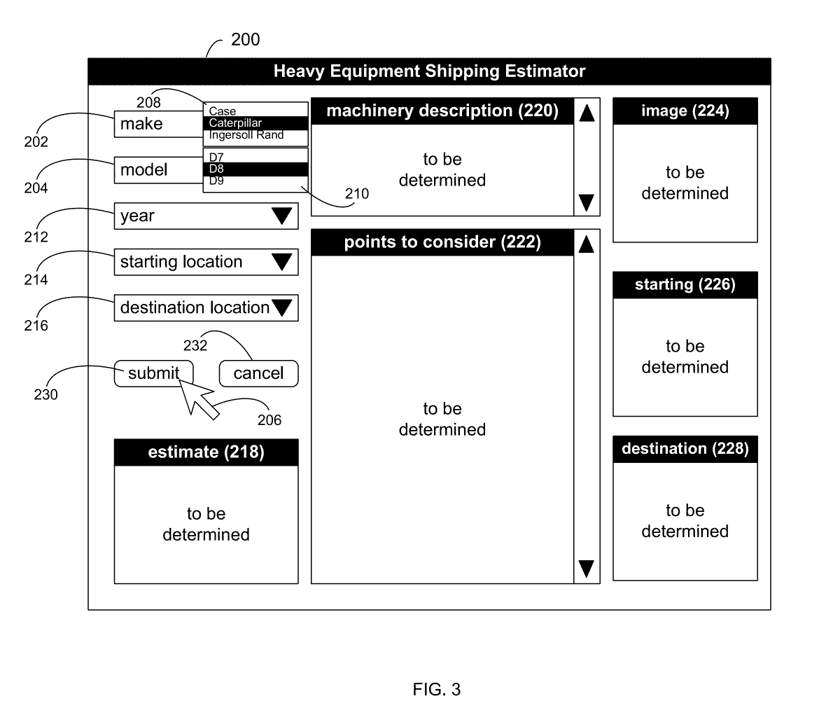

Referring also to FIGS. 2-3, assume for illustrative purposes that user 42 would like to ship bulldozer 54 from a first location (e.g., Louisville, Ky.) to a second location (e.g., Mobile, Ala.). Accordingly, user 42 may use shipping estimation process 10 to initiate 100 a shipping inquiry (e.g., shipping inquiry 56) and calculate 102 a shipping estimate (e.g., shipping estimate 58) concerning the cost associated with shipping bulldozer 54 from Louisville, Ky. to Mobile, Ala.

Continuing with the above-stated example, user 36 may enter the appropriate URL into a standard web browser (e.g., Microsoft Internet Explorer™ or Google Chrome™) and may be directed to shipping estimation process 10. Shipping estimation process 10 may render user interface 200, which may be configured to allow user 42 to enter the appropriate descriptive information (concerning bulldozer 54) so that shipping estimation process 10 may generate shipping estimate 58.

User interface 200 may include a plurality of fields that are configured to enable user 42 to enter the information required to generate shipping estimate 58. For example, user interface 200 may include make field 202 and model field 204 that may be configured to allow e.g., user 42 to define 104 a manufacturer/model for the piece of heavy equipment (e.g., bulldozer 54). Assume for illustrative purposes that bulldozer 54 is a 2003 Caterpillar D8.

When defining 104 the manufacturer/model for the piece of heavy equipment (e.g., bulldozer 54), shipping estimation process 10 may render 106 a list of heavy equipment manufacturers and define 108 a selected manufacturer chosen from the list of heavy equipment manufacturers (in response to a manufacture selection made by e.g., user 42).

Accordingly and via onscreen pointer 206 (controllable via a mouse; not shown), user 42 may select make field 202, resulting in shipping estimation process 10 rendering 106 the list of heavy equipment manufacturers (e.g., in the form of dropdown menu 208). User 42 may then select (in this example) “Caterpillar” from within dropdown menu 208, resulting in shipping estimation process 10 defining 108 the manufacturer as “Caterpillar”.

When defining 104 the manufacturer/model for the piece of heavy equipment (e.g., bulldozer 54), shipping estimation process 10 may further render 110 a list of heavy equipment models offered by the selected manufacturer (“Caterpillar”) and define 112 a selected model chosen from the list of heavy equipment models (in response to a model selection made by e.g., user 42).

Accordingly and via onscreen pointer 206, user 42 may select model field 204, resulting in shipping estimation process 10 rendering 110 the list of heavy equipment models (in the form of dropdown menu 210). User 42 may then select (in this example) “D8” from within dropdown menu 210, resulting in shipping estimation process 10 defining 112 the model as “D8”.

When defining 104 the manufacturer/model for the piece of heavy equipment (e.g., bulldozer 54), shipping estimation process 10 may define 114 a year for the piece of heavy equipment (e.g., bulldozer 54), which may be defined by user 42 via year field 212 in a fashion similar to the manner in which the make/model of bulldozer 54 were defined 108, 112.

Further, shipping estimation process 10 may be configured to allow e.g., user 42 to identify 116 a starting location (via starting location field 214) for the piece of heavy equipment (e.g., bulldozer 54) and identify 118 a destination location (via destination location field 216) for the piece of heavy equipment (e.g., bulldozer 54).

User interface 200 may also include a plurality of portions that are configured to provide user 42 with information concerning shipping inquiry 56. For example, estimate portion 218 may define the cost of shipping the piece of heavy equipment (e.g., bulldozer 54) and the service provider (e.g., transport companies, carriers, haulers, brokers, freight forwarders, non-vessel operating common carriers, etc.) who will be performing the transport. Further, user interface 200 may include machinery description portion 220 that may provide user 42 with information concerning the piece of heavy equipment being shipped (e.g., bulldozer 54) and points to consider portion 222 that may provide user 42 with logistics information concerning the shipments of the piece of heavy equipment (e.g., bulldozer 54).

User interface 200 may further include image portion 224 that may be configured to provide user 42 with a stock image of the piece of heavy equipment (e.g., bulldozer 54); starting location portion 226 that may be configured to provide user 42 with a map of the starting location; and destination location portion 228 that may be configured to provide user 42 with a map of the destination location. Additionally, turn-by-turn directions (not shown) may be provided within user interface 200, wherein such directions may be based upon the route that the service provider may take in light of e.g., load height, width, length and/or weight). Further, a complete map (as opposed to just starting location portion 226 and destination location portion 228) may be provided within user interface 200.

Prior to calculating 102 shipping estimate 58; estimate portion 218, machinery description portion 220, points to consider portion 222, image portion 224, starting location portion 226 and destination location portion 228 may all be unpopulated.

When the appropriate number of fields are defined (e.g., make field 202, model field 204, year field 206, starting location field 214 and destination location field 218), shipping estimation process 10 may access 120 equipment database 60 to obtain a plurality of equipment characteristics for the specific piece of heavy equipment (e.g., bulldozer 54). At least one of the equipment characteristics may be assigned a weight, based at least in part, upon a level of shipping complexity associated with the equipment characteristic (as will be discussed below in greater detail).

Further and upon the appropriate number of fields being defined, shipping estimation process 10 may access 122 logistics database 62 to obtain at least one logistics criterion for the specific piece of heavy equipment (e.g., bulldozer 54). The at least one logistics criterion may define one or more logistical characteristics (as will be discussed below in great detail) for the specific piece of heavy equipment.

When the appropriate number of fields are defined (e.g., make field 202, model field 204, year field 206, starting location field 214 and destination location field 218), user 42 may select “submit” button 230 via onscreen pointer 206, resulting in shipping estimation process 10 initiating the process of calculating 102 shipping estimate 58. Alternatively, user 42 may select “cancel” button 232 via onscreen pointer 206.

Once initiated, shipping estimation process 10 may calculate 102 shipping estimate 58 for the piece of heavy equipment (e.g., bulldozer 54). When calculating 102 shipping estimate 58 for the piece of heavy equipment (e.g., bulldozer 54), shipping estimation process 10 may take into consideration one or more of the following: the manufacturer/model (e.g., Caterpillar D8) of the piece of heavy equipment (e.g., bulldozer 54), the starting location (e.g., Louisville, Ky.) of the piece of heavy equipment (e.g., bulldozer 54), the destination location (e.g., Mobile, Ala.) of the piece of heavy equipment (e.g., bulldozer 54), the year (e.g., 2003) of the piece of heavy equipment (e.g., bulldozer 54), one or more of the plurality of equipment characteristics (to be discussed below) of the piece of heavy equipment (e.g., bulldozer 54), and the at least one logistics criterion (to be discussed below) of the piece of heavy equipment (e.g., bulldozer 54). Once calculated, shipping estimate 58 may be provided to user 42. Additionally, shipping estimate 58 may be provided to the service provider defined within estimate portion 218.

The manner in which the various pieces of data discussed above are used by shipping estimation process 10 when calculating 102 shipping estimate 58 may vary depending upon the specific piece of data. For example, shipping estimation process 10 may utilize the starting location (e.g., Louisville, Ky.) and the destination location (e.g., Mobile, Ala.) to determine the total number of miles (621 miles) that the piece of heavy equipment (e.g., bulldozer 54) needs to be moved, which directly impacts price since greater distances require more time and burn more fuel.

Further, shipping estimation process 10 may consider the weight of the piece of heavy equipment (e.g., bulldozer 54) when generating shipping estimate 58, as heavier pieces of equipment burn more fuel per mile when they are being moved. Additionally, the more the piece of heavy equipment weighs, the larger the vehicle required to move the same.

As discussed above, shipping estimation process 10 may access 120 equipment database 60 to obtain a plurality of equipment characteristics for the specific piece of heavy equipment (e.g., bulldozer 54), wherein this plurality of equipment characteristics may define one or more physical characteristics of the specific piece of heavy equipment (e.g., bulldozer 54). Since user 42 defined the make (e.g., Caterpillar) and model (D8) of bulldozer 54, shipping estimation process 10 may access 120 equipment database 60 to obtain equipment characteristics for a Caterpillar D8, examples of which may include but are not limited to length (186″), width (101″), height (84″) and weight (80.000 lbs.). As discussed above, one or more of the equipment characteristics may be assigned a weight, based at least in part, upon a level of shipping complexity associated with the equipment characteristic. For example, as bulldozer 54 (in this example) weights 80,000 lbs., this is a considerably heavy load. Accordingly and when calculating 102 shipping estimate 58, shipping estimate process 10 may assign a higher weight to the physical weight of bulldozer 54 (as opposed to the length, width or height of bulldozer 54), as the weight of bulldozer 54 may be more likely to complicate the shipping of bulldozer 54 (e.g., may require permits and/or special vehicles). Specifically, when the piece of heavy equipment has one or more physical characteristics that are much outside the norm (e.g., very heavy, very wide, very tall, very long), special permits may be required (e.g., for an overly heavy load, an overly tall load, an overly wide load and/or an overly long load; respectively), all of which increase the complexity of shipping the piece of heavy equipment and drive up the cost of the same.

Further and as discussed above, shipping estimation process 10 may access 122 logistics database 62 to obtain at least one logistics criterion concerning the specific piece of heavy equipment (e.g., bulldozer 54), which may be identified 124 (e.g., within shipping estimate 58) to user 42 (as will be discussed below in greater detail).

The above-described logistics criterion (or criteria) may define one or more logistical characteristics for the specific piece of heavy equipment. Examples of such logistical characteristics may include but are not limited to: one or more physical characteristics of the specific piece of heavy equipment; loading requirements/instructions; unloading requirements/instructions; shipping requirements/instructions; shipping disassembly instructions; and shipping reassembly instructions.

Loading requirements/instructions may include any special requirements/instructions concerning the manner in which the specific piece of heavy equipment needs to be loaded onto the vehicle(s) that will be transporting it. Specific example may include but are not limited to the requirement that the blade be removed from the specific piece of heavy equipment prior to shipping the same; the requirement that the tracks be removed from the specific piece of heavy equipment prior to shipping the same; and the requirement that the ROPS (i.e., Roll Over Protection System) of the specific piece of heavy equipment be removed from the specific piece of heavy equipment prior to shipping the same. Further, since the blade, tracks, and ROPS weigh several thousand pounds each, a crane may be required to load the same onto the trailers. Accordingly, a crane may be needed at the starting location of the specific piece of heavy equipment (e.g., bulldozer 54) and may drive up the cost of the shipment.

Other loading requirements/instructions may include but are not limited to whether the specific piece of heavy equipment is self-propelled (e.g., a bulldozer)/towable (e.g., a commercial grade compressor)/unwheeled (e.g., a wheel-less, industrial generator). If the specific piece of heavy equipment is towable, what kind of hitch does it have (e.g., a class 3, a gooseneck)? Can the specific piece of heavy equipment be loaded via a loading dock? Can the specific piece of heavy equipment climb up a ramp? Does the specific piece of heavy equipment need a lowboy trailer? Accordingly, various pieces of equipment (e.g., a crane, a tractor for towing, a loading dock) may be needed at the starting location of the specific piece of heavy equipment (e.g., bulldozer 54) and may drive up the cost of the shipment.

Unloading requirements/instructions may include any special requirements/instructions concerning the manner in which the specific piece of heavy equipment needs to be unloaded from the vehicle(s) that transported. Specific example may include but are not limited to the requirement that the blade be reinstalled onto the specific piece of heavy equipment after shipping the same; the requirement that the tracks be reinstalled onto the specific piece of heavy equipment after shipping the same; and the requirement that the ROPS of the specific piece of heavy equipment be reinstalled onto the specific piece of heavy equipment after shipping the same. Again, since the blade, tracks, and ROPS weigh several thousand pounds each, a crane may be required to unload the same from the trailers. Accordingly, a crane may be needed at the destination location of the specific piece of heavy equipment (e.g., bulldozer 54) and may drive up the cost of the shipment.

Other unloading requirements/instructions may include but are not limited to whether the specific piece of heavy equipment is self-propelled (e.g., a bulldozer)/towable (e.g., a towable, commercial grade compressor)/unwheeled (e.g., a wheel-less, industrial generator). If the specific piece of heavy equipment is towable, what kind of hitch does it have (e.g., a class 3, a gooseneck)? Can the specific piece of heavy equipment be unloaded via a loading dock? Can the specific piece of heavy equipment roll down a ramp? Accordingly, various pieces of equipment (e.g., a crane, a tractor for towing, a loading dock) may be needed at the destination location of the specific piece of heavy equipment (e.g., bulldozer 54) and may drive up the cost of the shipment.

Shipping requirements/instructions may include any special shipping requirements/instructions concerning the manner in which the specific piece of heavy equipment needs to be transported. Specific examples may include but are not limited to: over dimensional permit requirements/instructions for specific piece of heavy equipment (e.g., bulldozer 54); pilot/escort vehicle requirements/instructions for specific piece of heavy equipment (e.g., bulldozer 54); port readiness requirements/instructions for specific piece of heavy equipment (e.g., bulldozer 54); and trailer types/configurations that are required/capable of transporting the specific piece of heavy equipment (e.g., bulldozer 54).

Shipping disassembly instructions may include any special requirements/instructions concerning the manner in which the specific piece of heavy equipment needs to be disassembled prior to being loaded onto the vehicle(s) that will be transporting it. Specific examples may include but are not limited to instructions for removing the blade of the specific piece of heavy equipment prior to shipping the same, instructions for removing the tracks of the specific piece of heavy equipment prior to shipping the same, and instructions for removing the ROPS of the specific piece of heavy equipment prior to shipping the same.

Shipping reassembly instructions may include any special requirements/instructions concerning the manner in which the specific piece of heavy equipment needs to be reassembled after it is unloaded from the vehicle(s) that transported it. Specific examples may include but are not limited to instructions for reinstalling the blade of the specific piece of heavy equipment once shipping in complete, instructions for reinstalling the tracks of the specific piece of heavy equipment once shipping in complete, and instructions for reinstalling the ROPS of the specific piece of heavy equipment once shipping in complete.

As discussed above, when the appropriate number of fields are defined (e.g., make field 202, model field 204, year field 206, starting location field 214 and destination location field 218), user 42 may select “submit” button 230 via onscreen pointer 206, resulting in shipping estimation process 10 initiating the process of calculating 102 shipping estimate 58.

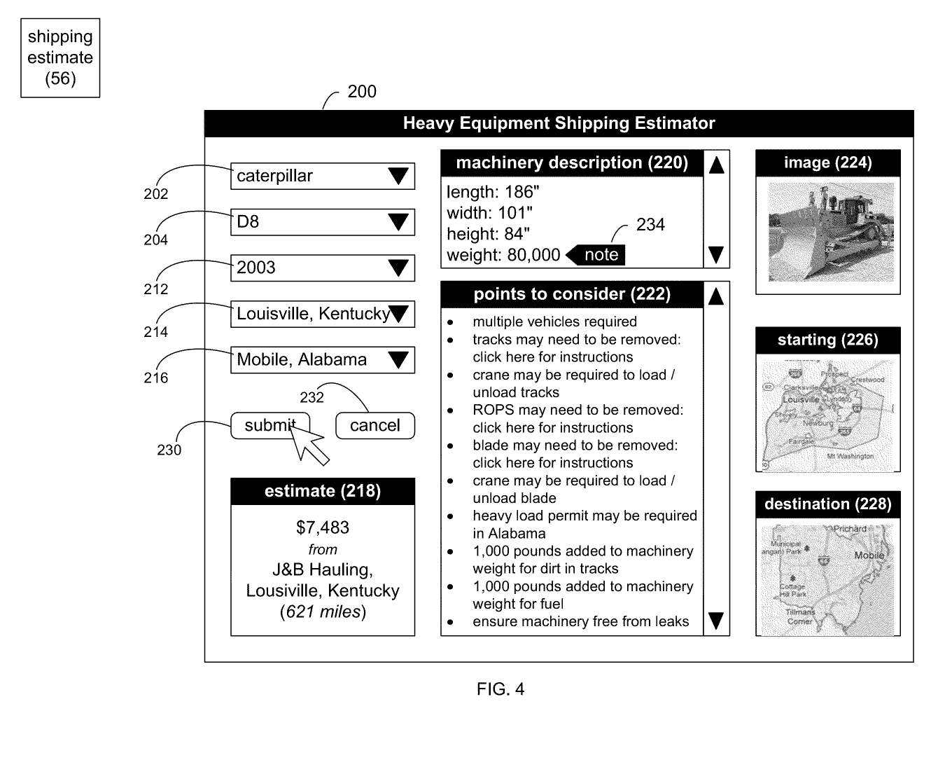

Accordingly, shipping estimation process 10 may calculate 102 shipping estimate 58, which may be provided to user 42. Additionally, shipping estimate 58 may also be provided to the service provider defined within estimate portion 218. Referring also to FIG. 4, there is shown a “populated” version of user interface 200, wherein image portion 224 is shown to include a stock image of the piece of heavy equipment (e.g., bulldozer 54); starting location portion 226 is shown to include a map of the starting location; and destination location portion 228 is shown to include a map of the destination location.

Further, estimate portion 218 is shown to define the estimate from J&B Hauling of Louisville, Ky. at $7,483 for shipping bulldozer 54 621 miles. As discussed above, user interface 200 may include machinery description portion 220 that may provide user 42 with information concerning the piece of heavy equipment being shipped and points to consider portion 222 that may provide user 42 with logistics information concerning the shipments of the piece of heavy equipment (e.g., bulldozer 54).

In this particular example, machinery description portion 220 is shown to define the physical characteristics of bulldozer 54, namely that bulldozer 54 is e.g., 186″ long, 101″ wide, 84″ high, and weighs 80,000 lbs.

In this particular example, points to consider portion 222 is shown to indicate several things. For example, the tracks of bulldozer 54 may need to be removed for transport. A link may be provided that may provide instructions to user 42 (or the service provider J&B Hauling of Louisville, Ky.) concerning how to remove the tracks of bulldozer 54. Additionally, the ROPS of bulldozer 54 may need to be removed for transport. A link may be provided that may provide instructions to user 42 (or the service provider J&B Hauling of Louisville, Ky.) concerning how to remove the tracks of bulldozer 54. Further, the blade of bulldozer 54 may need to be removed for transport. A link may be provided that may provide instructions to user 42 (or the service provider J&B Hauling of Louisville, Ky.) concerning how to remove the blade of bulldozer 54

Further, a crane may be required to load/unload the tracks, ROPS, and/or blade onto/from the transport vehicles. Depending upon the manner in which shipping estimate 58 is written, the expense of the crane may be the obligation of the shipper (user 42) or the service provider (J&B Hauling of Louisville, Ky.).

Additionally, as bulldozer 54 needs to be transported in several pieces, multiple vehicles may be required. Additionally, since the load alone weighs 80,000 lbs., a heavy load permit may be required in e.g., Alabama. Further, shipping estimation process 10 added 1,000 pounds to the machinery weight for dirt in the tracks and added 1,000 pounds to the machinery weight for fuel and liquids. Shipping estimation process 10 may recommend that user 42 and/or service provider J&B Hauling of Louisville, Ky. ensure that bulldozer 54 is free from leaks.

As discussed above, shipping estimation process 10 may access 122 logistics database 62 to obtain at least one logistics criterion concerning the specific piece of heavy equipment (e.g., bulldozer 54), which may be identified 124 (e.g., within shipping estimate 58) to user 42. Specifically, shipping estimation process 10 may identify 124 to user 42 one or more logistics criterion that may be off particular interest to user 42 (or the service provider). For example, notation 234 may be rendered by shipping estimation process 10 to draw the attention of user 42 (or the service provider) to the fact that bulldozer 54 weighs 80,000 lbs.

Shipping estimate 58 may be essentially a soft copy of the information presented to user 42 (and service provider J&B Hauling of Louisville, Ky.), which may be electronically transmitted to both parties. Assuming that user 42 agrees with the terms of shipping estimate 58, user 42 may effectuate the same (e.g., electronically via shipping estimation process 10, in writing via a traditional contact, or verbally via the telephone).

When calculating 102 shipping estimate 58, shipping estimation process 10 may generate shipping estimate 58 based upon preexisting terms that it has in place with various service providers (e.g., J&B Hauling of Louisville, Ky.). Accordingly, shipping estimation process 10 may identify local service providers, rate them (e.g., based upon price, feedback, reputation, etc.), negotiate terms with them, and generate shipping estimate 58 in accordance with those preexisting terms. Alternatively, shipping estimation process 10 may identify the preferred service provider and provide the pertinent information to the service provider so that the preferred service provider may respond to shipping inquiry 56 (and define the price and terms). Alternatively, shipping estimation process 10 may utilize a bidding process.

For example, when calculating 102 shipping estimate 58 for the piece of heavy equipment (e.g., bulldozer 54), shipping estimation process 10 may provide 126 the manufacturer/model (e.g., Caterpillar D8) of the piece of heavy equipment (e.g., bulldozer 54), the starting location (e.g., Louisville, Ky.) of the piece of heavy equipment (e.g., bulldozer 54), the destination location (e.g., Mobile, Ala.) of the piece of heavy equipment (e.g., bulldozer 54), one or more of the plurality of equipment characteristics for the piece of heavy equipment (e.g., bulldozer 54), and the at least one logistics criterion to one or more service providers (e.g., J&B Hauling of Louisville, Ky.). Shipping estimation process 10 may subsequently receive 128 one or more bids from the one or more service providers (e.g., J&B Hauling of Louisville, Ky.), wherein shipping estimate 58 is based, at least in part, upon the one or more bids received from the one or more service providers.

As discussed above, when the appropriate number of fields are defined (e.g., make field 202, model field 204, year field 206, starting location field 214 and destination location field 218), user 42 may select “submit” button 230 via onscreen pointer 206, resulting in shipping estimation process 10 initiating the process of calculating 102 shipping estimate 58.

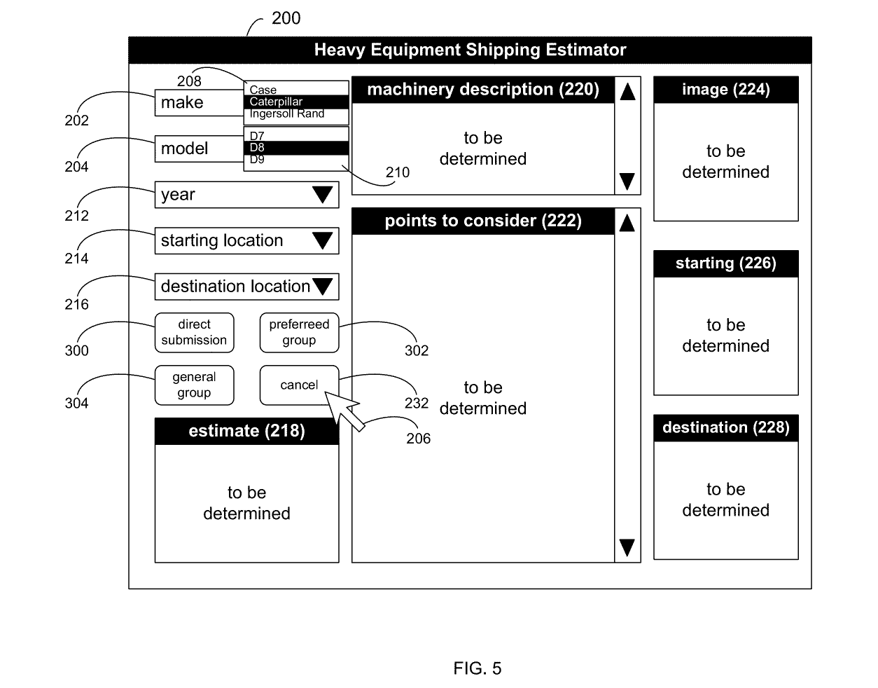

Referring also to FIG. 5, shipping estimation process 10 may be configured in a manner that allows the user (e.g., user 42) to control who receives shipping inquiry 56. For example, shipping estimation process 10 may be configured to allow the user (e.g., user 42) to submit shipping inquiry 56 in one of a variety of ways.

Accordingly, once the appropriate number of fields are defined within user interface 200, shipping inquiry 56 for moving a specific piece of heavy equipment (e.g., bulldozer 54) from a starting location (Louisville, Ky.) to a destination location (e.g., Mobile, Ala.) is defined 130. Shipping estimation process 10 may be configured to allow user 42 to select from a variety of shipping inquiry submission options.

The plurality of shipping inquiry submission options provided by shipping estimation process 10 may include: 1) at least one direct submission option that submits shipping inquiry 56 to a single preferred service provider (e.g., single preferred service provider 64), requesting that single preferred service provider 64 fulfill shipping inquiry 56; and 2) at least one bid submission option that submits shipping inquiry 56 to a predefined group of service providers, requesting that the members of the predefined group of service providers submit competitive bids for fulfilling shipping inquiry 56.

Further, the at least one bid submission option may include 1) a preferred bid submission option that submits shipping inquiry 56 to a predefined group of preferred service providers (e.g., predefined group of preferred service providers 66), requesting that the members of predefined group of preferred service providers 66 submit competitive bids for fulfilling shipping inquiry 56; and 2) a general bid submission option that submits shipping inquiry 56 to a predefined group of general service providers (e.g., predefined group of general service providers 68), requesting that the members of predefined group of general service providers 68 submit competitive bids for fulfilling shipping inquiry 56.

Accordingly, user interface 200 may be configured to include “direct submission” button 300, configured to submit shipping inquiry 56 to single preferred service provider 64 (e.g., J&B Hauling of Louisville, Ky.), requesting that single preferred service provider 64 (e.g., J&B Hauling of Louisville, Ky.) fulfill shipping inquiry 56. When shipping inquiry 56 is submitted using “direct submission” button 300, the level of compensation to be paid to single preferred service provider 64 for fulfilling shipping inquiry 56 may be defined within shipping inquiry 56 (in accordance with previously-negotiated terms). Alternatively, when shipping inquiry 56 is submitted using “direct submission” button 300, shipping inquiry 56 may inquire to single preferred service provider 64 (e.g., J&B Hauling of Louisville, Ky.) about the level of compensation to be paid to single preferred service provider 64 (e.g., J&B Hauling of Louisville, Ky.) for fulfilling shipping inquiry 56. Accordingly, if user 42 ships a considerable quantity of heavy equipment around the Louisville, Ky. area, user 42 may utilize shipping estimation process 10 to identify J&B Hauling of Louisville, Ky. as their preferred service provider (e.g., single preferred service provider 64).

Further, user interface 200 may be configured to include “preferred group” button 302, configured to submit shipping inquiry 56 to predefined group of preferred service providers 66, requesting that the members of predefined group of preferred service providers 66 submit competitive bids for fulfilling shipping inquiry 56. For example, assume that user 42 ships a large quantity of Caterpillar 375 series excavators, which requires a certain level of expertise to disassemble, ship and reassemble. Therefore, user 42 may utilize shipping estimation process 10 to define preferred group of preferred service providers 66 (possibly including J&B Hauling of Louisville, Ky.), wherein selecting “preferred group” button 302 results in shipping estimation process 10 submitting shipping inquiry 56 to each member of predefined group of preferred service providers 66.

Additionally, user interface 200 may be configured to include “general group” button 304, configured to submit shipping inquiry 56 to predefined group of general service providers 68, requesting that the members of predefined group of general service providers 68 submit competitive bids for fulfilling shipping inquiry 56. For example, assume that user 42 ships a large number of excavator buckets that require essentially no special expertise to ship. Therefore, user 42 may utilize shipping estimation process 10 to define predefined group of general service providers 68 (possibly including J&B Hauling of Louisville, Ky.), wherein selecting “general group” button 304 results in shipping estimation process 10 submitting shipping inquiry 56 to each member of predefined group of general service providers 68.

As discussed above, shipping estimation process 10 may be configured to receive 128 one or more competitive bids from the one or more service providers (e.g., single preferred service provider 64, preferred group of preferred service providers 66, and predefined group of general service providers 68), wherein shipping estimate 58 is based, at least in part, upon one or more of the bids received from the bid-submitting service providers. Accordingly, shipping estimation process 10 may receive 128 one or more competitive bids from single preferred service provider 64 and/or the members of the predefined group of service providers (e.g., either predefined group of preferred service providers 66 or predefined group of general service providers 68) for fulfilling the shipping inquiry, thus defining a pool of submitted bids. Further, shipping estimation process 10 may be configured to select 132 a chosen bid from the pool of submitted bids or may be configured to provide the top “X” bids to e.g., user 42 so that user may select the chosen bid.

### General

As will be appreciated by one skilled in the art, the present disclosure may be embodied as a method, a system, or a computer program product. Accordingly, the present disclosure may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, the present disclosure may take the form of a computer program product on a computer-usable storage medium having computer-usable program code embodied in the medium.

Any suitable computer usable or computer readable medium may be utilized. The computer-usable or computer-readable medium may be, for example but not limited to, an electronic, magnetic, optical, electromagnetic, infrared, or semiconductor system, apparatus, device, or propagation medium. More specific examples (a non-exhaustive list) of the computer-readable medium may include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a transmission media such as those supporting the Internet or an intranet, or a magnetic storage device. The computer-usable or computer-readable medium may also be paper or another suitable medium upon which the program is printed, as the program can be electronically captured, via, for instance, optical scanning of the paper or other medium, then compiled, interpreted, or otherwise processed in a suitable manner, if necessary, and then stored in a computer memory. In the context of this document, a computer-usable or computer-readable medium may be any medium that can contain, store, communicate, propagate, or transport the program for use by or in connection with the instruction execution system, apparatus, or device. The computer-usable medium may include a propagated data signal with the computer-usable program code embodied therewith, either in baseband or as part of a carrier wave. The computer usable program code may be transmitted using any appropriate medium, including but not limited to the Internet, wireline, optical fiber cable, RF, etc.

Computer program code for carrying out operations of the present disclosure may be written in an object oriented programming language such as Java, Smalltalk, C++ or the like. However, the computer program code for carrying out operations of the present disclosure may also be written in conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through a local area network/a wide area network/the Internet.

The present disclosure is described with reference to flowchart illustrations and/or block diagrams of methods, apparatus (systems) and computer program products according to embodiments of the disclosure. It will be understood that each block of the flowchart illustrations and/or block diagrams, and combinations of blocks in the flowchart illustrations and/or block diagrams, may be implemented by computer program instructions. These computer program instructions may be provided to a processor of a general purpose computer/special purpose computer/other programmable data processing apparatus, such that the instructions, which execute via the processor of the computer or other programmable data processing apparatus, create means for implementing the functions/acts specified in the flowchart and/or block diagram block or blocks.

These computer program instructions may also be stored in a computer-readable memory that may direct a computer or other programmable data processing apparatus to function in a particular manner, such that the instructions stored in the computer-readable memory produce an article of manufacture including instruction means which implement the function/act specified in the flowchart and/or block diagram block or blocks.

The computer program instructions may also be loaded onto a computer or other programmable data processing apparatus to cause a series of operational steps to be performed on the computer or other programmable apparatus to produce a computer implemented process such that the instructions which execute on the computer or other programmable apparatus provide steps for implementing the functions/acts specified in the flowchart and/or block diagram block or blocks.

The flowcharts and block diagrams in the figures may illustrate the architecture, functionality, and operation of possible implementations of systems, methods and computer program products according to various embodiments of the present disclosure. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustrations, and combinations of blocks in the block diagrams and/or flowchart illustrations, may be implemented by special purpose hardware-based systems that perform the specified functions or acts, or combinations of special purpose hardware and computer instructions.

The terminology used herein is for the purpose of describing particular embodiments only and is not intended to be limiting of the disclosure. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the present disclosure has been presented for purposes of illustration and description, but is not intended to be exhaustive or limited to the disclosure in the form disclosed. Many modifications and variations will be apparent to those of ordinary skill in the art without departing from the scope and spirit of the disclosure. The embodiment was chosen and described in order to best explain the principles of the disclosure and the practical application, and to enable others of ordinary skill in the art to understand the disclosure for various embodiments with various modifications as are suited to the particular use contemplated.

Having thus described the disclosure of the present application in detail and by reference to embodiments thereof, it will be apparent that modifications and variations are possible without departing from the scope of the disclosure defined in the appended claims.

What is claimed is:

1. A computer-implemented method for providing a shipping estimate to a user, the method comprising:
initiating a shipping inquiry for a specific piece of heavy equipment having a defined manufacturer/model;
accessing an equipment database to obtain a plurality of equipment characteristics for the specific piece of heavy equipment, wherein at least one of the equipment characteristics is assigned a weight, based at least in part, upon a level of shipping complexity associated with the equipment characteristic; and
calculating the shipping estimate for the specific piece of heavy equipment based, at least in part, upon the defined manufacturer/model of the specific piece of heavy equipment, and one or more of the plurality of equipment characteristics.

2. The computer-implemented method of claim 1 further comprising:
identifying a starting location for the specific piece of heavy equipment; and
identifying a destination location for the specific piece of heavy equipment.

3. The computer-implemented method of claim 2 wherein calculating the shipping estimate for the specific piece of heavy equipment includes:
calculating the shipping estimate for the specific piece of heavy equipment based, at least in part, upon the defined manufacturer/model of the specific piece of heavy equipment, one or more of the plurality of equipment characteristics, the starting location of the specific piece of heavy equipment, and the destination location of the specific piece of heavy equipment.

4. The computer-implemented method of claim 1 further comprising:
providing the shipping estimate to the user.

5. The computer-implemented method of claim 1 wherein calculating the shipping estimate for the specific piece of heavy equipment includes:
providing the defined manufacturer/model of the specific piece of heavy equipment, and one or more of the plurality of equipment characteristics to one or more service providers; and
receiving one or more bids from the one or more service providers;
wherein the shipping estimate is based, at least in part, upon the one or more bids received from the one or more service providers.

6. The computer-implemented method of claim 1 wherein the plurality of equipment characteristics define one or more physical characteristics of the specific piece of heavy equipment.

7. The computer-implemented method of claim 6 wherein each of the plurality of equipment characteristics is assigned a weight, based at least in part, upon the level of shipping complexity associated with the equipment characteristic.

8. A computer program product residing on a computer readable medium having a plurality of instructions stored thereon which, when executed by a processor, cause the processor to perform operations comprising:
initiating a shipping inquiry for a specific piece of heavy equipment having a defined manufacturer/model;
accessing an equipment database to obtain a plurality of equipment characteristics for the specific piece of heavy equipment, wherein at least one of the equipment characteristics is assigned a weight, based at least in part, upon a level of shipping complexity associated with the equipment characteristic; and
calculating the shipping estimate for the specific piece of heavy equipment based, at least in part, upon the defined manufacturer/model of the specific piece of heavy equipment, and one or more of the plurality of equipment characteristics.

9. The computer program product of claim 8 further comprising instructions for:
identifying a starting location for the specific piece of heavy equipment; and
identifying a destination location for the specific piece of heavy equipment.

10. The computer program product of claim 9 wherein calculating the shipping estimate for the specific piece of heavy equipment includes:
calculating the shipping estimate for the specific piece of heavy equipment based, at least in part, upon the defined manufacturer/model of the specific piece of heavy equipment, one or more of the plurality of equipment characteristics, the starting location of the specific piece of heavy equipment, and the destination location of the specific piece of heavy equipment.

11. The computer program product of claim 8 further comprising instructions for:
providing the shipping estimate to the user.

12. The computer program product of claim 8 wherein calculating the shipping estimate for the specific piece of heavy equipment includes:
providing the defined manufacturer/model of the specific piece of heavy equipment, and one or more of the plurality of equipment characteristics to one or more service providers; and
receiving one or more bids from the one or more service providers;
wherein the shipping estimate is based, at least in part, upon the one or more bids received from the one or more service providers.

13. The computer program product of claim 8 wherein the plurality of equipment characteristics define one or more physical characteristics of the specific piece of heavy equipment.

14. The computer program product of claim 13 wherein each of the plurality of equipment characteristics is assigned a weight, based at least in part, upon the level of shipping complexity associated with the equipment characteristic.

15. A computing system including a processor and memory configured to perform operations comprising:
initiating a shipping inquiry for a specific piece of heavy equipment having a defined manufacturer/model;
accessing an equipment database to obtain a plurality of equipment characteristics for the specific piece of heavy equipment, wherein at least one of the equipment characteristics is assigned a weight, based at least in part, upon a level of shipping complexity associated with the equipment characteristic; and
calculating the shipping estimate for the specific piece of heavy equipment based, at least in part, upon the defined manufacturer/model of the specific piece of heavy equipment, and one or more of the plurality of equipment characteristics.

16. The computing system of claim 15 further configured to perform operations comprising:
identifying a starting location for the specific piece of heavy equipment; and
identifying a destination location for the specific piece of heavy equipment.

17. The computing system of claim 16 wherein calculating the shipping estimate for the specific piece of heavy equipment includes:
calculating the shipping estimate for the specific piece of heavy equipment based, at least in part, upon the defined manufacturer/model of the specific piece of heavy equipment, one or more of the plurality of equipment characteristics, the starting location of the specific piece of heavy equipment, and the destination location of the specific piece of heavy equipment.

18. The computing system of claim 15 further configured to perform operations comprising:
providing the shipping estimate to the user.

19. The computing system of claim 15 wherein calculating the shipping estimate for the specific piece of heavy equipment includes:
providing the defined manufacturer/model of the specific piece of heavy equipment, and one or more of the plurality of equipment characteristics to one or more service providers; and
receiving one or more bids from the one or more service providers;
wherein the shipping estimate is based, at least in part, upon the one or more bids received from the one or more service providers.

20. The computing system of claim 15 wherein the plurality of equipment characteristics define one or more physical characteristics of the specific piece of heavy equipment.

21. The computing system of claim 20 wherein each of the plurality of equipment characteristics is assigned a weight, based at least in part, upon the level of shipping complexity associated with the equipment characteristic.
